(19) United States
(12) Patent Application Publication
(10) Pub. No.: US 2006/0236553 A1
(43) Pub. Date: Oct. 26, 2006

(54) Device for visual positioning

(76) Inventor: Jean-Bernard Chas, Etretat (FR)

Correspondence Address: YOUNG & THOMPSON, 745 SOUTH 23RD STREET, 2ND FLOOR, ARLINGTON, VA, 22202, US

(21) Appl. No.: 10/550,464

(22) PCT Filed: Mar. 24, 2004
(86) PCT No.: PCT/FR04/00732

§ 371 Date: Sep. 26, 2005

(30) Foreign Application Priority Data
Mar. 25, 2003 (FR) 03/03674

(51) Int. Cl. G01C 3/00

(52) U.S. Cl. 33/277

(57) ABSTRACT

A device for visual positioning of the type including a fixed scale (2), arranged on a base (1), defining an axis (Y), for pointing at a first landmark (5), at least two moving scales (6, 7), generating the axes (X, Z), concurrent with the axis (Y), for pointing at other landmarks (10, 13), jointed about an assembly piece (22), fixed to the base (1), provided with a hole (14) in the centre thereof, at least one steerable plate (15) or a steerable prism on a pivot, inserted in a fixed manner into said hole (14). The plate (15) or the prism permits a simultaneous direct sighting of the first landmark (5) and a reflected sighting of at least one of the other landmarks (10, 13). The invention is characterised in including elements for facilitating and speeding up the positioning of the axes (X, Y, Z), following or simultaneous to the orientation of the plate (15) or prism.

The present invention relates to devices intended for visual self-positioning according to the method of subtended arcs, making it possible both to observe the angular deviations between the landmarks and the plotting of the corresponding position on the map.

The device according to the invention is a refinement of the invention described in documents FR-A-1 450 588 and U.S. Pat. No. 3,410,642.

For the safety of navigation, it is out of the question to rely only on electronic positioning technologies. Despite apparent precision, an automatic system may give false indications that are difficult to discern inside the system itself. It remains subject to emissions of signals prone to faults or to anomalies of propagation. The user is exposed to errors of agreement of the coordinate systems used. The receiver apparatus may be damaged, fall into the water. It is therefore still necessary to be able to cross check the information originating from several independent systems (radio navigation, astronomical navigation, reckoning, sounding lines, bearings).

In sight of land, entitled to no longer believe anything other than what he sees when the dangers multiply, the navigator deterred from the practice of taking cross bearings, on account of the manifest facilities offered by electronic devices, often encounters difficulties in determining the corrections of the compass or of the terrestrial magnetic field, applying them east or west, reading and plotting the bearings. At worst, he compounds the errors, at best, he compounds the lack of precision.

Relatively inexpensive, foolproof, requiring no source of energy, purely optical and manual devices shelter the user from such errors or uncertainties. In addition to checking the plausibility of the other systems used, they allow extremely reliable and precise positioning. Their simplicity earns them their rightful place on board alongside sophisticated technologies based on electronics.

A problem which arises during the use of these optical devices lies in the difficulties encountered in observing by reflected vision.

The device described in FR-A-1 450 588 and U.S. Pat. No. 3,410,642 remedies same, and allows both the observation of the position and its plotting on the map. It consists essentially of three superposed, orientable transparent scales each furnished with an end foresight, and with a plate (mirror) pivoting perpendicularly to the plane of the scales at the intersection of their sighting axes. The plate has transparent and reflecting portions, a vertical edge of the transparent portion being aligned with the axis of rotation of the plate and of the scales.

Observation is done in two stages, based on two lateral landmarks situated on either side of a central landmark. The image in the mirror of a first lateral landmark is brought onto the central landmark placed in direct line of sight on the central axis, by orientation of the pivoted mirror, then the lateral axis is aligned with the central axis by searching for it in the mirror of the plate and by superposing the two foresights. The operation is repeated for the second lateral landmark.

The alignment of the lateral scale does not modify the prior orientation of the mirror, since the assembly piece of the three scales constitutes a gudgeon for the pivoted plate and is integral with the central scale.

The axes being fixed in position with fastening studs, the removable pivoted plate is detached so as to apply the axes to the map, making them pass through the points locating the corresponding landmarks, and the position of the boat is plotted at their intersection in the orifice of the gudgeon.

U.S. Pat. No. 4,245,393 and U.S. Pat. No. 4,383,372 were granted to an invention allowing the simultaneous observation of the three landmarks by a device similar to the previous one in certain aspects.

These documents describe two embodiments. The first has the particular feature of dispensing with any mirror. The second comprises, in order to observe by reflected vision, not one mirror at the center, but a mirror of sextant type on each of the lateral scales and two target mirrors on the central scale, sending the images to a common eyepiece on the rear of the central scale.

The mirrorless device suffers from insufficient precision, the eye being unable to position itself exactly at the point of convergence and to sight satisfactorily at one and the same time along the three axes. In the other case, the multiplying up of the mirrors added to the compulsory passage through an eyepiece considerably reduces the field of vision.

The configuration with one mirror placed at the intersection of the three sighting axes as advocated by FR-A-1 450 588 and U.S. Pat. No. 3,410,642 advantageously makes it possible, in order to find and retain the image in the mirror, to have recourse to just one reflection. In respect of this same advantage it makes it possible to dispense with the eyepiece since the boundary between its transparent part and its reflecting part serves therefor when sighting along the three axes.

The purpose of the invention is to propose a refinement of this device aimed at facilitating the use thereof, and at curtailing the duration required for taking the bearing of a position.

Accordingly the subject of the invention is a device for visual positioning, of the type comprising a fixed scale mounted on a base defining an axis (Y), intended to be pointed toward a first landmark, at least two movable scales demarcating axes (X, Z) concurrent with the axis (Y) and intended to be pointed toward other landmarks, articulated about an assembly piece fixed to the base provided at its center with a perforation, at least one orientable plate or an orientable prism mounted on a pivot inserted in a removable manner in said perforation, said plate or said prism allowing simultaneously direct sighting of the first landmark and reflected sighting of at least one of the other landmarks, characterized in that it comprises means for facilitating and curtailing the positioning of the axes (X, Y, Z) subsequent to or simultaneously with the orientation of the plate or of the prism.

Said fixed scale may be placed between two movable scales.

Said means for facilitating and curtailing the positioning of the axes may be constituted by a graduated ring fashioned on the periphery of the base.

Said means may be constituted by means making it possible to slave the rotation of said movable scales to the rotation of the at least one plate or prism.

Said means making it possible to slave the rotation of the movable scales to the rotation of the at least one plate or prism may then comprise notched sectors carried by the movable scales, notched wheels associated with said notched sectors, and at least one notched wheel that can be rendered integral with the plate or with the prism and associated with at least one pinion that can be meshed with one or other of the notched sectors.

The device may comprise a number of plates or prisms, of notched wheels and of pinions which is equal to the number of movable scales.

Said plate may comprise a recessed part, of which an edge is situated on the axis of articulation (T) of the movable scales and a reflecting part on at least one of its faces.

Said plate may be both transparent and reflecting over the whole of its surface.

Said scales may comprise foresights situated on said axes.

As will have been understood, the present invention is therefore directed at means of associating the orientation of the movable scales with that of the mirror-forming plate or the prism in a simple and effective manner so as to find easily, or even automatically, the foresight of the movable scale in the field of the mirror. This makes it possible to facilitate and curtail the plotting of the position. The shortening of the duration of the plot makes it possible to decrease the errors that may originate from an appreciable variation in the position of the boat during the plotting operation itself.

According to a first embodiment, the orientation of the mirror or of the prism not being tied to those of the scales, a graduated ring printed on the base integral with the fixed scale and on which the movable scales pivot makes it possible to place the axis of the movable scale symmetrically with the axis of the fixed scale with respect to the mirror or to the prism, so as to easily find its foresight there and complete the alignment of the scale if necessary.

According to a second embodiment, the device according to the invention comprises a mechanism for slaving the orientation of each moveable scale to that of the mirror or of the prism, for example by wheels and sectors linked without slippage by notchings or other devices playing the same role, be this by friction of adhesive materials or by belts.

The invention will be better understood on reading the description which follows, given with reference to the following appended figures:

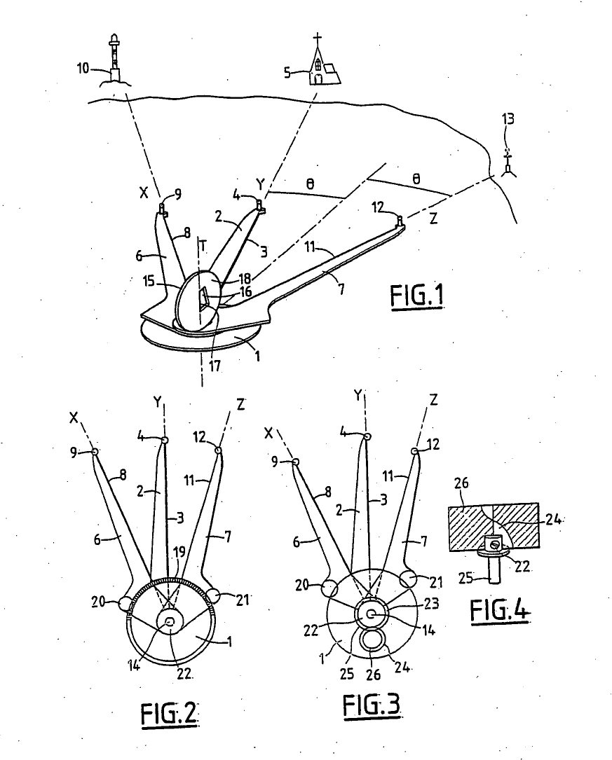

FIG. 1 which represents, seen in perspective, the general principle of a device to which the invention applies;

FIG. 2 which represents, seen from above, a first exemplary device according to the invention;

FIG. 3 which represents, seen from above, a second exemplary device according to the invention;

FIG. 4 which represents seen in profile a detail of the device of FIG. 3.

FIG. 1 recalls the general principle of the design of a device that the invention aims to improve. It comprises a circular base 1 carrying a central fixed scale 2, of which a straight edge 3 defines a fixed axis Y. The end of the fixed scale 2 carries a foresight 4 placed on the Y axis and intended for sighting a first landmark 5 termed the central landmark. Articulated about the central region of the base 1 and able to turn about an axis T passing through the center of the base 1 are two superposed lateral movable scales 6, 7. The first movable scale 6 has a straight edge 8 defining an X axis and carries at its end a foresight 9 placed on the X axis for sighting a first lateral landmark 10. The second movable scale 7 has, likewise, a straight edge 11 defining a Z axis and a foresight 12 placed on the Z axis for sighting a second lateral landmark 13. At its center, where the axes (X, Y, Z) cross, the base 1 comprises an orifice 14 into which may be inserted rotatably a rod carrying a plate 15. This plate 15 is preferably oval (as represented) rather than rectangular, so as to increase the field of vision when sighting and to decrease wind resistance. It comprises a recess 16 allowing direct sighting of the central landmark 5, and a side 17 of which coincides with the axis T. The remainder of the plate 15 is constituted by a reflecting surface 18 where the lateral landmarks 10, 13 may be reflected. This recessed/reflecting plate 15 could be replaced with any other type of device affording the same functions, such as a prism or a uniformly semitransparent plate. The mode of use of this device was recalled in the introduction to this text.

In FIGS. 2 and 3, the plate 15 has been omitted for greater clarity.

According to the first variant of the invention, represented in FIG. 2, the periphery of the base 1 carries a graduated ring 19 making it possible to determine the angular offset between the Y axis and the plate 15 on the one hand, the X axis and the Z axis on the other hand. In this way, when the user has determined the angular position of the plate 15 which allows him to superpose the central landmark 5 with the reflection of one of the lateral landmarks 10, 13, the graduated ring allows him to read the value of the angle θ formed by the X axis and the plate 15. The user then places that one of the movable scales 6, 7, which corresponds to the lateral landmark 10, 13 which has been sighted, at the angular position 20. Normally, he ought then to immediately obtain the superposition of the corresponding foresight 9, 12 with the central landmark 5. In addition, just a slight alteration of the angular position of the movable scale 6, 7 is necessary in order to hone the adjustment. This simple operation makes it possible to shorten the time devoted to the fine sighting of the lateral landmarks 10, 13. After each sighting, the position of the corresponding movable scale 6, 7 is locked on the base by means of a thumbwheel 20, 21. The plate 15 is then removed from the orifice 14, and the device is placed on the map in such a way that the X, Y, Z axes each pass through the positions of their respective landmarks 10, 5, 13. The position of the boat is given by the location on the map of the center of the orifice 14.

According to the second embodiment, represented in FIGS. 3 and 4, the rotation of the moveable scales 6, 7 is alternately slaved to that of the plate 15. In this way, the correct angular position of each movable scale 6, 7 is obtained simultaneously with the obtaining of the superposition of the central landmark 5 with the reflection of the corresponding lateral landmark 10, 13, and no alteration is necessary.

According to a nonlimiting example, the assembly piece 22 for the scales, the upper part of which serves as gudgeon for the plate 15, is represented with the same diameter as the ends of the movable scales 6, 7 sliding one on the other and comprising a notched sector 23. These notched sectors 23 are associated at their level with notched wheels 24 of like diameter. The orientable plate 15 is integral with a notched wheel 25 associated with a pinion 26. They are dimensioned for example in a ratio of one to two. The pinion 26 integral with its pin has two possible positions by translation along its axis, interchangeable when the X and Z axis are superposed. It remains meshed with the notched wheel 25 in one or the other position. The purpose of the translation is to engage the notched sector of one or the other scale 6, 7 with the pin of the pinion 26. To change movable scale 6, 7 after the first observation, the lateral axes X and Z are again superposed. The plate 15 is reset in position with the lateral axis X and the central axis Z superposed. Its reflecting surface 18 is advantageously fashioned on the two faces of the plate 15 so as not to have to turn it over. The mechanism is preferably partially encased in a shell (not represented) integral with the assembly piece for the movable scales 6, 7 and the base 1 on the central scale 2. The shell passes under the notched wheel 25 of the plate 15 and under the pinion 26 regardless of its position. This shell comprises, as well as the base 1, a journal for the common pin shared by the pinion 26 and the notched wheels 24.

The observation is done is two stages, the plate 15 drives one or the other of the movable scales 6, 7 until there is superposition of the central landmark 5 and of the central foresight 4 by direct sighting with the lateral landmark 10 or 13 and of the lateral foresight 9 or 12 by reflected sighting. The two movable scales 6, 7 having been fixed in position with the thumbwheels 20, 21 and the plate 15 having been removed, the three axes X, Y, Z are made to pass through the positions corresponding on the map to the landmarks 5, 10, 13 observed, and the pencil is introduced into the orifice 14 of the gudgeon in order to plot the position at their intersection.

The refinement pertains also to the plate 15 whose function is essentially to simultaneously ensure a direct view and a reflected view as well as to demarcate the axes of sighting at their intersection. Apart from using a semitransparent material (both transparent and reflecting) or a prism simultaneously allowing both views in a satisfactory manner, according to a nonlimiting embodiment, it has advantageously been possible to reduce the field of direct view to the benefit of the field of reflected view, by extending the reflecting surface 18 on both sides of the axis T. The reflecting surface 18 is preferably present on both sides of the axis affording a direct view of one or more transparent or recessed surfaces 16, the axis of direct view remaining demarcated by the boundary 17 between transparent part 16 and reflecting part 18. Initial usage may be facilitated, for however much time it takes to become accustomed thereto, by a larger plate 15 whose main drawback is wind resistance.

The X, Y, Z axes being unable to be applied to the map along their whole length, the scales 5, 6, 7 being superposed, better than by transparency or through a groove, their axes demarcated by one of the sides 3, 8, 11 of the scales 2, 6, 7, slit vertically, may be superposed with the landmarks 5, 10, 13 on the map with no parallax error. This also allows the use of pegs as an aid in guiding the search for conjunction of the passage of the three axes X, Y, Z through the three landmarks 10, 5, 13.

The scales 2, 6, 7 are preferably of slightly different lengths so as to orient them on one and the same axis without coming into abutment against the foresights 4, 9, 12.

According to a nonlimiting embodiment or mode of use of the device according to the invention, observation is carried out on three landmarks 5, 10, 13 in two stages, on either side of the central landmark 5, the observation of additional landmarks being carried out through new operations. Without departing from the spirit of this invention the addition of one or more further scales is possible so as to observe further landmarks in one and the same operation.

Simultaneous observation of the three landmarks 5, 10, 13 is also possible in accordance with the invention by superposing two plates that can be oriented independently of one another, the sighting marks at the end of the scales advantageously being raised up so as, very rigorously, to sight in two parallel planes. The lower plate is in two parts assembled on a tube at the center is mounted on a pivot of annular section. It permits passage of the cylindrical pivot of the upper plate in its sighting axis and in its pivot.

The association of the rotation of the plates with that of the corresponding movable scale is effected in the same manner with the aid of the notched ring. The slaving of the orientation of the movable scales to that of their plate each furnished with a drive wheel is obtained through a mechanism similar to that shown diagrammatically in FIG. 4, independent for each scale and arranged on each side of the fixed scale, the movable scales being redesigned so that this new arrangement does not impede their orientation.

Other devices for slaving the position of the movable scales to the orientation of the plate or plates other than that which has been described are conceivable. Such devices could for example use belts or friction surfaces rather than notches.

The device may, without departing from the boundaries of the invention, accommodate graduations intended for uses other than positioning by the method of subtendable arcs, such as proportional compasses or protractors.

In the variant described and represented, the movable scales flank the fixed scale (which is materially solid with the base but could also be a piece added onto the base). However this arrangement is not compulsory: the movable scales could very well be situated on the same side of the fixed scale. It would then no longer be justifiable to speak of “central landmark” and “lateral landmarks”, but it would then be possible to speak, in general, of “first landmark” to designate the landmark sighted by the axis of the fixed scale and of “other landmarks” to designate the landmarks sighted by the axes of the movable scales.

1. A device for visual positioning, of the type comprising a fixed scale (2) mounted on a base (1) defining an axis (Y), intended to be pointed toward a first landmark (5), at least two movable scales (6, 7) demarcating axes (X, Z) concurrent with the axis (Y) and intended to be pointed toward other landmarks (10, 13), articulated about an assembly piece (22) fixed to the base (1) provided at its center with a perforation (14), at least one orientable plate (15) or an orientable prism mounted on a pivot inserted in a removable manner in said perforation (14), said plate (15) or said prism allowing simultaneously direct sighting of the first landmark (5) and reflected sighting of at least one of the other landmarks (10, 13), characterized in that it comprises means for facilitating and curtailing the positioning of the axes (X, Y, Z) subsequent to or simultaneously with the orientation of the plate (15) or of the prism.

2. The device as claimed in claim 1, characterized in that said fixed scale (2) is placed between two movable scales (6, 7).

3. The device as claimed in claim 1, characterized in that said means for facilitating and curtailing the positioning of the axes (X, Y, Z) are constituted by a graduated ring (19) fashioned on the periphery of the base (1).

4. Device according to claim 1, characterized in that said means are constituted by means making it possible to slave the rotation of said movable scales (6, 7) to the rotation of the at least one plate (15) or prism.

5. The device as claimed in claim 4, characterized in that said means making it possible to slave the rotation of the movable scales (6, 7) to the rotation of the at least one plate (15) or prism comprise notched sectors (22) carried by the movable scales (6, 7), notched wheels (24) associated with said notched sectors (22), and at least one notched wheel (25) that can be rendered integral with the plate (15) or with the prism and associated with at least one pinion (27) that can be meshed with one or other of the notched sectors (22).

6. The device as claimed in claim 5, characterized in that it comprises a number of plates (15) or prisms, of notched wheels (25) and of pinions (26) which is equal to the number of movable scales (6, 7).

7. The device as claimed in claim 1, characterized in that said plate (15) comprises a recessed part (16), of which an edge (17) is situated on the axis of articulation (T) of the movable scales (6, 7) and a reflecting part (18) on at least one of its faces.

8. The device as claimed in claim 1, characterized in that said plate (15) is both transparent and reflecting over the whole of its surface.

9. The device as claimed in claim 1, characterized in that said scales (2, 6, 7) comprise foresights (4, 9, 12) situated on said axes (Y, X, Z).

10. The device as claimed in claim 2 characterized in that said means for facilitating and curtailing the positioning of the axes (X, Y, Z) are constituted by a graduated ring (19) fashioned on the periphery of the base (1).
